(19) United States
(12) Patent Application Publication
(10) Pub. No.: US 2018/0124778 A1
(43) Pub. Date: May 3, 2018

(54) BACK-TO-BACK UPLINK TRANSMISSIONS FROM MULTIPLE STATIONS

(71) Applicant: QUALCOMM Incorporated, San Diego, CA (US)

(72) Inventors: Lochan VERMA, San Diego, CA (US); Sameer VERMANI, San Diego, CA (US); Bin TIAN, San Diego, CA (US); Alfred ASTERJADHI, San Diego, CA (US)

(21) Appl. No.: 15/799,163

(22) Filed: Oct. 31, 2017

Related U.S. Application Data
(60) Provisional application No. 62/416,090, filed on Nov. 1, 2016.

(51) Int. Cl. H04W 72/04; H04L 27/26

(52) U.S. Cl. CPC H04W 72/0413; H04W 88/08; H04L 27/2626; H04W 72/0446

(57) ABSTRACT

The present disclosure describes a method and an apparatus for techniques used for back-to-back uplink transmissions from multiple stations in wireless local area networks (WLANs). An example method includes transmitting, from the AP, a control frame to the plurality of STAs, wherein the control frame contains configuration information related to a plurality of consecutive transmission slots; and receiving, at the AP, back-to-back uplink (UL) response frames from the plurality of STAs in the plurality of consecutive transmission slots. An additional example method includes receiving, at the STA, a control frame from the AP, wherein the control frame contains configuration information related to a plurality of consecutive transmission slots; and transmitting, from the STA, uplink (UL) response frames in one or more transmission slots of the plurality of consecutive transmission slots based at least on the configuration information in the control frame.

### CLAIM OF PRIORITY UNDER 35 U.S.C. § 119

The present Application for Patent claims priority to U.S. Provisional Application No. 62/416,090 entitled “BACK-TO-BACK UPLINK TRANSMISSIONS FROM MULTIPLE STATIONS” filed Nov. 1, 2016, which is assigned to the assignee hereof and hereby expressly incorporated by reference herein.

### BACKGROUND

The present disclosure relates generally to communication systems, and more particularly, to techniques for uplink transmissions in wireless local area networks (WLANs).

In some Wi-Fi/WLAN networks, an access point (AP) may transmit a trigger frame for every transmission slot. Wireless stations (STAs) associated with the AP receive the trigger frame and may transmit uplink (UL) response frames in respective transmission slots based on the STAs scheduled for transmission of UL response frames in the trigger frame. The AP may have to wait for at least a duration of an inter-frame space (e.g., distributed inter-frame space (DIFS) and a backoff) prior to the transmission of a next trigger frame to the STAs. In some cases, the AP may have to wait for a duration of the DIFS only (backoff duration not needed) if the AP is performing transmissions within a transmission opportunity (TXOP) the AP has secured. The inter-frame space may be a short inter frame space (SIFS) and is generally configured for 16 μs in IEEE 802.11ac/ax. Once the AP waits for the duration of the inter-frame space or the DIFS, the AP may send another trigger frame which is associated with another transmission slot to the STAs, and the STAs respond accordingly. The trigger frame can send information associated with only one transmission slot and may have to wait for a duration of the inter-frame space or DIFS prior to transmitting the next trigger frame to send information associated with a subsequent transmission slot.

Thus, there is a desire to send a trigger frame or a control frame that may include information associated with multiple transmission slots and without the need for inter-frame spaces between transmission of successive control frames.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with an aspect, a method of communications between an AP and a plurality of STAs in a WLAN is provided. The described aspects include transmitting, from the AP, a control frame to the plurality of STAs, wherein the control frame contains configuration information related to a plurality of consecutive transmission slots. The described aspects further include receiving, at the AP, back-to-back UL response frames from the plurality of STAs in the plurality of consecutive transmission slots.

In another aspect, a method of communications between a STA and AP in a WLAN is provided which may include receiving, at the STA, a control frame from the AP, wherein the control frame contains configuration information related to a plurality of consecutive transmission slots. The described aspects further include transmitting, from the STA, UL response frames in one or more transmission slots of the plurality of consecutive transmission slots based at least on the configuration information in the control frame.

In accordance with an aspect, an apparatus for communications between an AP and a plurality of STAs in a WLAN is provided. The described further aspects include means for transmitting, from the AP, a control frame to the plurality of STAs, wherein the control frame contains configuration information related to a plurality of consecutive transmission slots. The described aspects further include means for receiving, at the AP, back-to-back UL response frames from the plurality of STAs in the plurality of consecutive transmission slots.

In another aspect, an apparatus for communications between a STA and AP in a WLAN is provided which may provide means for receiving, at the STA, a control frame from the AP, wherein the control frame contains configuration information related to a plurality of consecutive transmission slots. The described aspects further include means for transmitting, from the STA, UL response frames in one or more transmission slots of the plurality of consecutive transmission slots based at least on the configuration information in the control frame.

In accordance with an aspect, an apparatus for communications between an AP and a plurality of STAs in a WLAN is provided. The described aspects include a memory configured to store data and one or more processors communicatively coupled with the memory, wherein the one or more processors and the memory are configured to transmit, from the AP, a control frame to the plurality of STAs, wherein the control frame contains configuration information related to a plurality of consecutive transmission slots. The described aspects further receive, at the AP, back-to-back UL response frames from the plurality of STAs in the plurality of consecutive transmission slots.

In another aspect, the example apparatus includes a memory configured to store data; and one or more processors communicatively coupled with the memory, wherein the one or more processors and the memory are configured to receive, at the STA, a control frame from the AP, wherein the control frame contains configuration information related to a plurality of consecutive transmission slots. The described aspects further transmit, from the STA, UL response frames in one or more transmission slots of the plurality of consecutive transmission slots based at least on the configuration information in the control frame.

In accordance with an aspect, a computer-readable medium storing computer executable code for communications between an AP and a plurality of STAs in a WLAN is provided. The described aspects further include code for transmitting, from the AP, a control frame to the plurality of STAs, wherein the control frame contains configuration information related to a plurality of consecutive transmission slots. The described aspects further include code for receiving, at the AP, back-to-back UL response frames from the plurality of STAs in the plurality of consecutive transmission slots.

In another aspect, the computer readable medium storing computer executable code for communications between a STA and AP in a WLAN may include code for receiving, at the STA, a control frame from the AP, wherein the control frame contains configuration information related to a plurality of consecutive transmission slots. The described aspects further include code for transmitting, from the STA, UL response frames in one or more transmission slots of the plurality of consecutive transmission slots based at least on the configuration information in the control frame.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a block diagram of a wireless system within which the example aspects may be implemented.

FIGS. 2A and 2B illustrate an AP transmitting an example excitation frame and/or receiving uplink response frames from a plurality of STAs in accordance with some aspects.

FIG. 3 illustrates an example overview of an excitation frame in accordance with some aspects.

FIGS. 4A and 4B illustrate example overviews of a payload arrangement in example excitation frames in accordance with some aspects.

FIG. 5 illustrates an example overview of fields of a common information block and/or a user specific information block in accordance with some aspects.

FIG. 6 illustrates an example overview of an uplink response frame structure in accordance with some aspects.

FIG. 7 illustrates an example aspect of an excitation frame transmitted to a plurality of STAs in accordance with some aspects.

FIG. 8A illustrates an example control frame, e.g., a trigger frame in 802.11ax standard.

FIG. 8B illustrates another example aspect of an excitation frame transmitted to a plurality of STAs in accordance with some aspects.

FIG. 9 illustrates another additional example aspect of an excitation frame transmitted to a plurality of STAs in accordance with some aspects.

FIG. 10 illustrates an example methodology for communications between an access point and a plurality of wireless stations in a wireless network in accordance with some aspects.

FIG. 11 illustrates another example methodology for communications between a STA and an AP in a wireless network in accordance with some aspects.

### DETAILED DESCRIPTION

In the following description, numerous specific details are set forth such as examples of specific components, circuits, and processes to provide a thorough understanding of the present disclosure. The term “coupled” as used herein means coupled directly to or coupled through one or more intervening components or circuits. Also, in the following description and for purposes of explanation, specific nomenclature is set forth to provide a thorough understanding of the present aspects. However, it will be apparent to one skilled in the art that these specific details may not be required to practice the present aspects. In other instances, well-known circuits and devices are shown in block diagram form to avoid obscuring the present disclosure. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components.

Some portions of this disclosure which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In this disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout this disclosure, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “initiating,” “broadcasting,” “identifying,” “obtaining,” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure generally relates to techniques for uplink transmissions in wireless local area networks (WLANs). For example, a WLAN may be formed by one or more APs that provide a shared wireless communication medium for use by a number of client devices such as STAs. Each AP, which may correspond to a Basic Service Set (BSS), periodically broadcasts beacon frames to enable any STAs within wireless range of the AP to establish and/or maintain a communication link with the AP. In a typical WLAN, only one STA may use the wireless medium at any given time, and each STA may be associated with only one AP at a time.

Due to the increasing ubiquity of wireless communication networks, when an STA seeks to join a wireless network, the STA may have a choice between multiple wireless communication networks and/or between multiple APs that form an extended BSS. Another wireless communication network may include, for example, a fifth generation (5G) wireless communications technology (which can be referred to as new radio (NR)) is envisaged to expand and support diverse usage scenarios and applications with respect to current mobile network generations. In an aspect, 5G communications technology can include: enhanced mobile broadband addressing human-centric use cases for access to multimedia content, services and data; ultra-reliable-low latency communications (URLLC) with certain specifications for latency and reliability; and massive machine type communications, which can allow a very large number of connected devices and transmission of a relatively low volume of non-delay-sensitive information.

As the STA is moved into the coverage area of one or more wireless networks, the STA may select the best AP with which to associate. After the STA becomes associated with the selected AP, the STA may be moved within and/or between the coverage area of the one or more wireless networks, and may subsequently benefit from switching its association from the currently associated AP to one of a number of candidate APs (e.g., APs with which the STA is not associated), for example, to achieve the highest possible data rate.

Moreover, as the frequency band for WLANs increases to a 6 GHz frequency band, enabling various wireless communication networks and/or protocols to operate within at least a portion of the 6 GHz frequency band may be desired. For example, at least a portion of the 6 GHz frequency band may correspond to an unlicensed frequency band and be shared with a 5G wireless communications network. Therefore, different wireless communication networks may be scheduled based on a trigger based scheme. That is, WLAN communications may be scheduled based a time-division scheme. In an example, STAs operating in the WLAN may be scheduled for communications for a specified period of time so as to not interfere with communications on the 6 GHz frequency band from other STAs operating using another wireless communication network. Thus, a need exists for optimizing the scheduling of communications within this specified period of time so that inter-frame spaces between communications do not go unused.

Specifically, in an aspect, the present aspects may enable an AP to transmit a control frame, for example, an excitation frame to a plurality of STAs. The control frame or the excitation frame may be referred to as a trigger frame or an enhanced trigger frame. The excitation frame includes transmission slot configuration which identifies the transmission slots during which a particular STA may transmit. The transmission slot configuration includes information associated with multiple consecutive transmission slots. Upon receiving the excitation frame from the AP, a STA may read the excitation frame and transmit UL response frames to the AP based on the transmission slot configuration in the excitation frame. STAs transmitting in the first transmission slot wait for a duration of an inter-frame space prior to transmitting the UL response frames and transmit for the duration of the multiple transmissions slots without any further inter-frame spaces in the following transmission slots.

The example aspects are described below in the context of a mobile or a STA operating in a WLAN system for simplicity only. It is to be understood that the example aspects are equally applicable to other types of devices and/or to other wireless networks (e.g., cellular networks, pico networks, femto networks, satellite networks). As used herein, the terms “wireless local area network (WLAN)” and “Wi-Fi” can include communications governed by the IEEE 802.11 or later family of standards. Further, although described below in terms of an infrastructure WLAN system including one or more APs, the example aspects are equally applicable to other WLAN systems including, for example, multiple WLANs, Independent Basic Service Set (IBSS) networks, ad-hoc networks, peer-to-peer (P2P) networks (e.g., operating according to the Wi-Fi Direct protocols), and/or Hotspots.

In addition, although described herein in terms of exchanging data frames between wireless devices, the example aspects may be applied to the exchange of any data unit, packet, and/or frame between wireless devices. Thus, the term “frame” may include any frame, packet, or data unit such as, for example, protocol data units (PDUs), media access control (MAC) protocol data units (MPDUs), and physical layer convergence procedure protocol data units (PDUs). The term “A-MPDU” may refer to aggregated MPDUs.

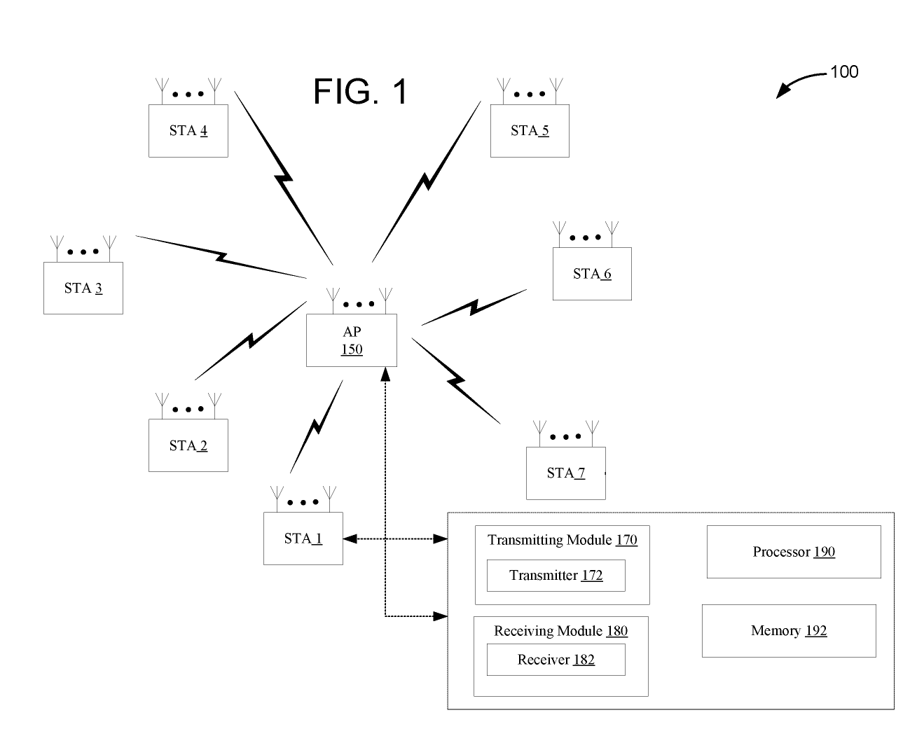

FIG. 1 is a block diagram of a wireless system 100 within which the example aspects may be implemented. The wireless network 100 is shown with one wireless nodes, generally designated as an Access Point (AP) 150 and multiple wireless stations (STAs) 1-7. Each wireless node is capable of receiving and/or transmitting. In the detailed description that follows, the term “access point” is used to designate a transmitting node and the term “wireless station” or “station” is used to designate a receiving node for downlink communications, whereas the term “access point” is used to designate a receiving node and the term “wireless station” or “station” is used to designate a transmitting node for uplink communications. However, those skilled in the art will readily understand that other terminology or nomenclature may be used for an access point and/or an access terminal. By way of example, an access point may be referred to as a base station, a base transceiver station, a station, a terminal, a node, an access terminal acting as an access point, or some other suitable terminology. A wireless station may be referred to as a station, user terminal, a mobile station, a subscriber station, a station, a wireless device, a terminal, a node, or some other suitable terminology. The various concepts described throughout this disclosure are intended to apply to all suitable wireless nodes regardless of their specific nomenclature.

The wireless network 100 may support any number of access points distributed throughout a geographic region to provide coverage for any number of wireless stations. AP 150 and/or STAs 1-7 may include a transmitting module 170 and/or a receiving module 180 for transmitting and/or receiving. For simplicity, only one access point 150 and 7 STAs are shown in FIG. 1. In an aspect, AP 150 and/or STAs 1-7 may work with future versions of IEEE 802.11ax standard or new WLAN (e.g., Wi-Fi) standards and/or may be backwards compatible with current IEEE 802.11ax standard.

For example, in an aspect, an access point is generally a fixed terminal that provides backhaul services to access terminals in the geographic region of coverage. However, the access point may be mobile in some applications. An access terminal, which may be fixed or mobile, utilizes the backhaul services of an access point or engages in peer-to-peer communications with other access terminals. Examples of access terminals include a telephone (e.g., cellular telephone), a laptop computer, a desktop computer, a Personal Digital Assistant (PDA), a digital audio player (e.g., MP3 player), a camera, a game console, or any other suitable wireless node.

In an aspect, the wireless network 100 may support MIMO technology. Using MIMO technology, AP 150 may communicate with multiple STAs 1-7 simultaneously using Spatial Division Multiple Access (SDMA). SDMA is a multiple access scheme which enables multiple streams transmitted to different receivers at the same time to share the same frequency channel and, as a result, provide higher user capacity. This is achieved by spatially precoding each data stream and then transmitting each spatially pre-coded stream through a different transmit antenna on the downlink. The spatially pre-coded data streams arrive at the access terminals with different spatial signatures, which enable each STA to recover the data stream destined for that access terminal. On the uplink, each STA transmits a spatially pre-coded data stream, which enables the access point 150 to identify the source of each spatially pre-coded data stream.

The AP 150 is assigned a unique media access control (MAC) address that may be programmed therein by, for example, the manufacturer of the AP. Similarly, the STAs may also be assigned with a unique MAC address. Once the STA is authenticated to and associated with an AP, the STA and the AP may exchange data with each other over a shared wireless channel or link.

More specifically, establishing a WLAN connection between an AP and an STA typically involves a number of steps to be completed before the STA and the AP may begin exchanging data with each another. First, the STA typically scans all available channels (e.g., by broadcasting probe requests and/or by listening for beacon frames) to identify APs and/or other devices that are within wireless range of the STA. Each available AP may respond to the probe requests by transmitting, to the STA, a probe response containing basic service set (BSS) information pertaining to that AP's network. Next, the STA selects one of the APs with which to associate. For example, the STA may select the AP having the highest signal strength or having the highest goodput. Then, authentication may be performed between the STA and AP and the STA may associate with the selected AP. For the example illustrated in FIG. 1, the STAs are associated with AP 150, and may exchange signals or frames with the AP 150.

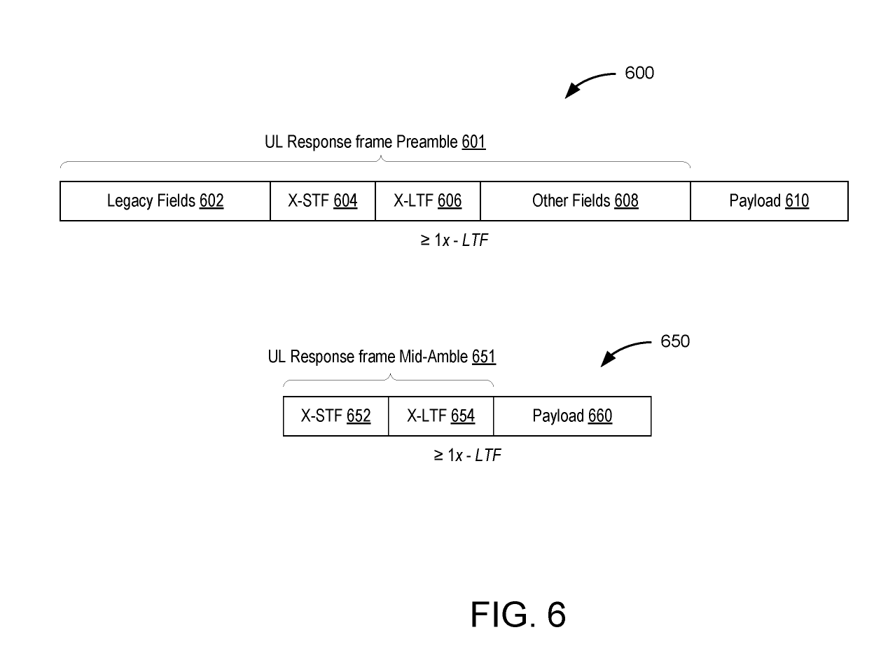

The STA may be any suitable WLAN enabled wireless device including, for example, a mobile station (MS), personal digital assistant (PDA), tablet device, laptop computer, or the like. The STA may also be referred to as a user equipment (UE), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. For at least some aspects, the STA may include one or more transceivers, one or more processing resources (e.g., processors and/or ASICs), one or more memory resources, and a power source (e.g., a battery). The memory resources may include a non-transitory computer-readable medium (e.g., one or more nonvolatile memory elements, such as EPROM, EEPROM, Flash memory, a hard drive, etc.) that stores instructions for performing operations described below with respect to FIGS. 6 and/or 9.

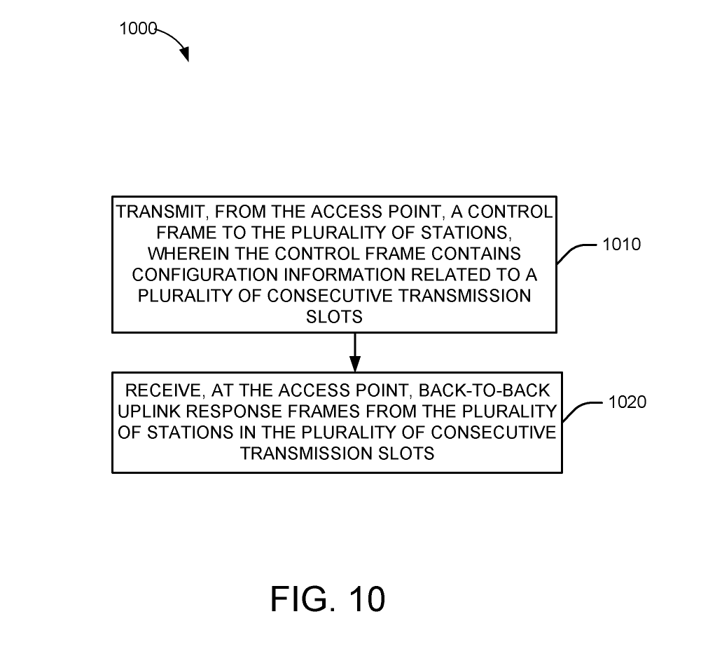

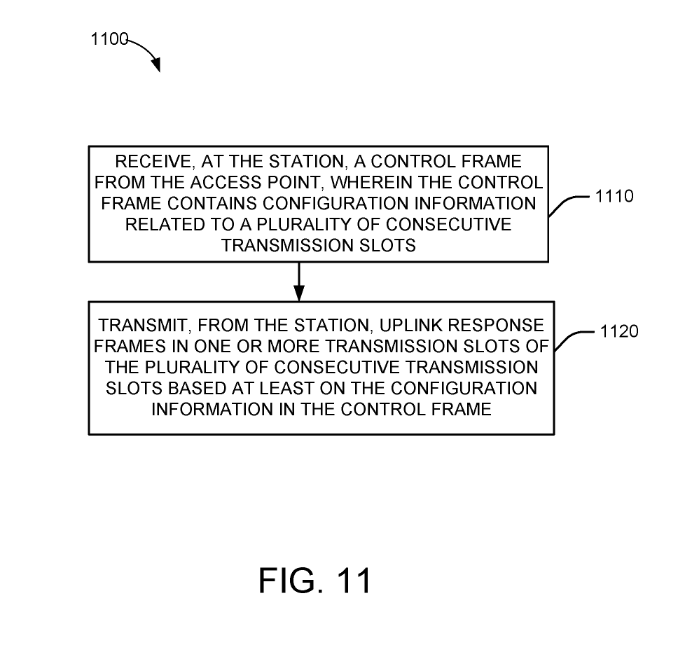

The AP 150 may be any suitable device that allows one or more wireless devices to connect to a network (e.g., a local area network (LAN), wide area network (WAN), metropolitan area network (MAN), and/or the Internet) via the AP 150 using Wi-Fi, Bluetooth, or any other suitable wireless communication standards. For at least one aspect, AP 150 may include a transmitting module 170 which may include one or more transmitters 172 and a receiving module 180 which may include one or more receivers 182, one or more processing resources (e.g., processors and/or ASICs) 190, one or more memory resources 192, and a power source (not shown). The memory resources may include a non-transitory computer-readable medium (e.g., one or more nonvolatile memory elements, such as EPROM, EEPROM, Flash memory, a hard drive, etc.) that stores instructions for performing operations described below with respect to FIGS. 10 and 11.

A STA (e.g., STAs 1-7) may be any suitable WLAN enabled wireless device including, for example, a mobile station (MS), personal digital assistant (PDA), tablet device, laptop computer, or the like. The STA may also be referred to as a user equipment (UE), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. For at least some aspects, the STA may include a transmitting module 170 which may include one or more transmitters 172 and a receiving module 180 which may include one or more receivers 182, one or more processing resources (e.g., processors and/or ASICs) 190, one or more memory resources 192, and a power source, e.g., a battery (not shown). The memory resources may include a non-transitory computer-readable medium (e.g., one or more nonvolatile memory elements, such as EPROM, EEPROM, Flash memory, a hard drive, etc.) that stores instructions for performing operations described below with respect to FIGS. 10 and 11.

For the STAs 1-7 and/or AP 150, the one or more transceivers may include WLAN transceivers, Bluetooth transceivers, cellular transceivers, and/or other suitable radio frequency (RF) transceivers (not shown for simplicity) to transmit and receive wireless communication signals. Each transceiver may communicate with other wireless devices in distinct operating frequency bands and/or using distinct communication protocols. For example, the WLAN transceiver may communicate within a 2.4 GHz frequency band, within a 5 GHz frequency band, and/or within a 60 GHz frequency band. The cellular transceiver may communicate within various RF frequency bands in accordance with a 4G Long Term Evolution (LTE) protocol described by the 3rd Generation Partnership Project (3GPP) (e.g., between approximately 700 MHz and approximately 3.9 GHz) and/or in accordance with other cellular protocols (e.g., Global System for Mobile (GSM) communications, Universal Mobile Telecommunications System (UMTS) protocols). In other aspects, the transceivers included within the STA and/or the APs 110A-110F may be any technically feasible transceiver such as a ZigBee transceiver described by a specification from the ZigBee specification, a WiGig transceiver, and/or a HomePlug transceiver described a specification from the HomePlug Alliance.

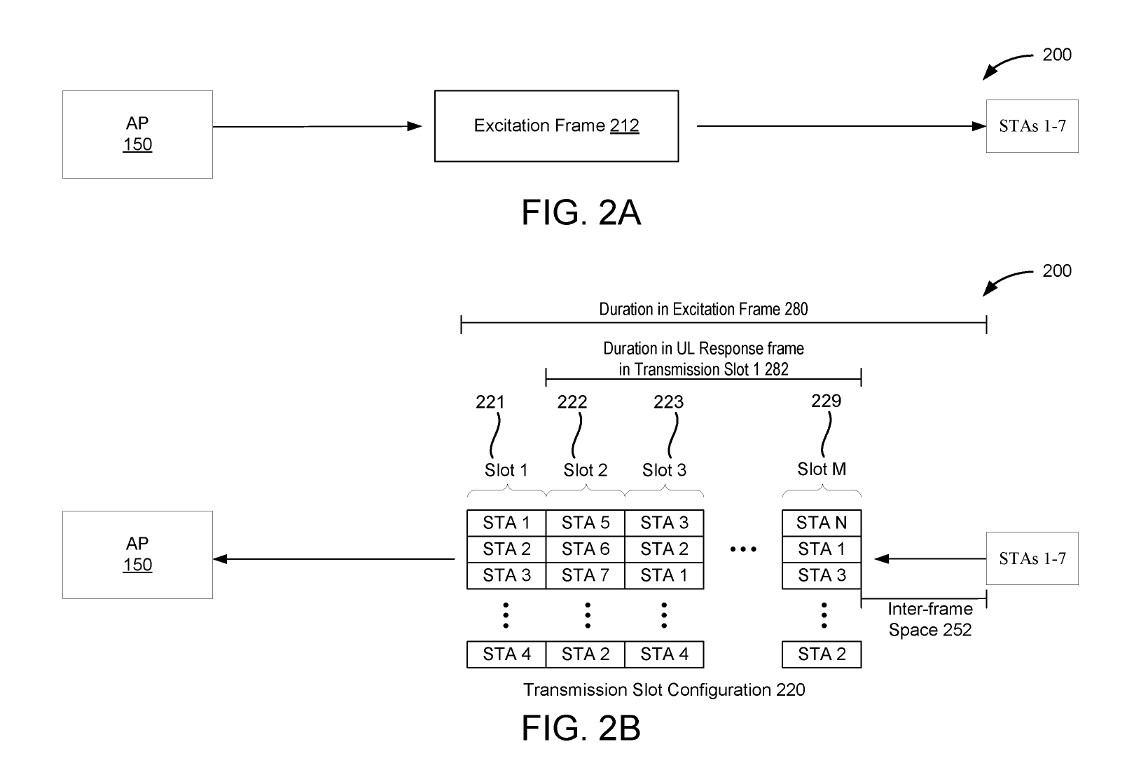

FIGS. 2A and 2B illustrate an example signaling flow diagram 200 of an AP transmitting an example control frame or excitation frame and/or receiving uplink (UL) response frames from a plurality of STAs in accordance with some aspects. The control frame or excitation frame transmitted from the AP to the STAs enables the STAs for transmitting back-to-back UL response frames from the STAs to the AP. For example, back-to-back UL response frames correspond to a plurality of UL response frames configured without inter-frame spaces between each of the plurality of UL response frames.

In an aspect, the AP 150 may transmit a control frame, which may be an excitation frame 212 to a plurality of STAs, e.g., STAs 1-7 of FIG. 1. The AP 150 may multicast or broadcast the excitation frame 212 to the STAs. The excitation frame 212 may contain configuration information, e.g., transmission slot configuration 220, for multiple contiguous transmission slots. For instance, the transmission slots may be transmission slots 1-M which may be used by the STAs 1-7 for sending back-to-back UL response frames to the AP 150. That is, the excitation frame 212 includes transmission slot configuration (or configuration information) associated with the transmission slots which the STAs use to determine when a particular or specific STA may transmit.

For example, the excitation frame 212 may configure STAs 1, 2, 3, and 4 to transmit uplink response frames during transmission slot 1 221, STAs 5, 6, 7, and 2 to transmit uplink response frames during transmission slot 2 222, STAs 3, 2, 1, and 4 to transmit uplink response frames during transmission slot 3 223, and/or STAs N, 1, 3, and 2 to transmit uplink response frames during transmission slot M, and so on. As illustrated in FIGS. 2A and 2B, the excitation frame 212 may include transmission slot configuration (information) for multiple transmission slots, e.g., slots 1-M. This is in contrast to the control frame in the current 802.11ax standard where the control frame can include configuration information for only one transmission slot.

On the receiving end, the STAs 1-7 receive the excitation frame 212 which is broadcasted or multicasted, and transmit uplink response frames as per the transmission slot configuration 220 received in the excitation frame 212. For example, STA 1 may transmit uplink response frames during transmission slot 1 221, transmission slot 2 222, transmission slot 3 223, and/or transmission slot M 229. However, it should be noted that there is an inter-frame space 252 between the transmission of the excitation frame 212 from the AP 150 and the transmission of uplink response frames by STA 1 in the transmission slot 1 221. For example, the inter-face space 252 corresponds to a period of time that one or more the STAs 1-7 wait before transmission of the uplink response frames. The inter-frame space 252 provides some time to the STAs to process the incoming excitation frame 212. Additionally, the excitation frame 212 includes transmission slot configuration in such a way that the transmission slots are consecutive. That is, there are no gaps between the transmission slots so that a third party STA or a device has little or no chance to grab the channel in between the transmission slots. Further, in an aspect, each of the transmission slots are configured to carry information which may include a transmission slot number, a frequency resource, spatial beam configuration, and/or a transmit power so that the STAs may use this information for transmitting the UL response frames to the AP 150.

A duration field, e.g., 280, 282, etc. may be present in a media access control (MAC) header of both the excitation frame 212 and UL response frames, e.g., UL response frame 600 and/or 650 of FIG. 6. The duration field may contain a time duration required to transmit the pending data and any inter-frame spaces 252. For example, the excitation frame 212 may include information corresponding to the duration in excitation frame 280 and/or the duration in UL response frame in transmission slot 1 282. In an aspect, for example, the duration in excitation frame 280 includes information pertaining to the time duration required to transmit the pending data and any inter-frame spaces 252. In another aspect, for example, the duration in UL response frame in transmission slot 1 282 also includes information pertaining to the time duration required to transmit the pending data and any inter-frame spaces 252, however, it is included in the MAC header of the UL response frames.

In an additional aspect, for example, in an UL response frame transmitted in the last transmission slot (e.g., slot M), the duration field in the UL response frame may be set to “zero” as there are no more UL response frames to be transmitted that are associated with the transmission slot configuration 220. In an additional aspect, a value of the duration field may also governed by acknowledgement (ACK) policy setting.

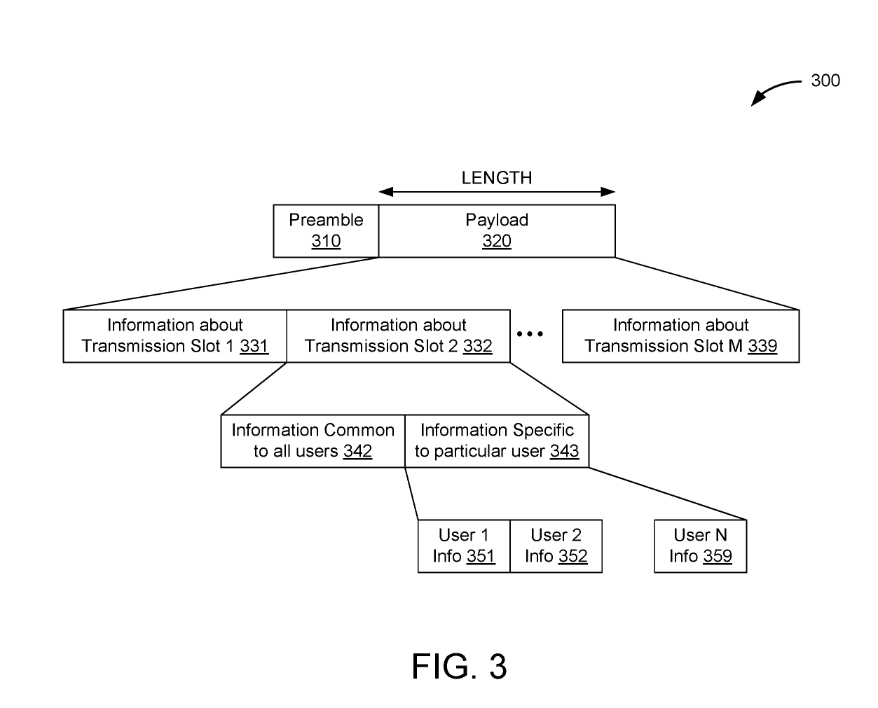

FIG. 3 illustrates an example overview of an excitation frame 300 in accordance with some aspects. For example, the excitation frame may include scheduling information related to the plurality of consecutive transmission slots for each of a plurality of STAs. The scheduling information may configure the plurality of STAs to transmit the back-to-back UL response frames as orthogonal frequency-division multiple access (OFDMA) transmissions. Other wireless communication technologies, such as LTE and/or 5G, do not transmit an excitation frame. In an example, for LTE enabled networks, the scheduling information for STAs is established via a dedicated control pipe.

In an aspect, for example, the excitation frame 300 (similar to excitation frame 212) may include a preamble 310 and a payload 320. The preamble 310 indicates a LENGTH of the payload 320. The LENGTH may indicate a size (e.g., in octets) of the physical service data unit (PSDU). The preamble 310 may also include other parameters (e.g., a RATE) to determine the duration of the excitation frame 300. As the AP 150 broadcasts or multicasts the excitation frame 300, the excitation frame 300 may be received by third party STAs/devices in the vicinity. A third party STA may defer its own transmissions for a duration the third party STA calculates based at least on the LENGTH and the RATE received in the preamble 310 of the excitation frame 300. In other words, the third party STA may wait for a duration that includes DIFS and backoff (e.g., DIFS+backoff) at the end of the LENGTH duration. However, the DIFS+backoff duration may be longer than the inter-frame space (e.g., SIFS) used by to access the channel by the STAs transmitting back-to-back UL response frames. Hence, a third party STA may defer again based on the LENGTH in the preamble of the back-to-back UL response frames. On the other hand, a “length” field in an information common to all users block (e.g., 342) of an excitation frame indicates the length (e.g., in octets) of the UL response frame to be transmitted in back-to-back UL transmission slot. In an aspect, a STA performing back-to-back UL transmissions (or sending back-to-back UL response frames) copies a value in the length field to the LENGTH field in preamble of the back-to-back UL response frame from the STA. Optionally, the third party devices may use another channel as well.

The payload 320 may include fields that relay information about the various transmission slots. For example, the payload 320 field may include information about transmission slot 1 331, information about transmission slot 2 332, and/or information about transmission slot M 339. The information about transmission slot may further contain fields such as information common to all users and/or information specific to particular user for all users. For example, the information about transmission slot #2 332 may further contain information common to all users 342 and information specific to particular user 343. Furthermore, the information specific to particular user field may contain user info for the various users (STAs) scheduled for transmission of UL response frames. For example, the information specific to particular user 343 field may contain user info that is specific for users 1 to N, e.g., user 1 info 351, user 2 info 352, and/or user N info 359.

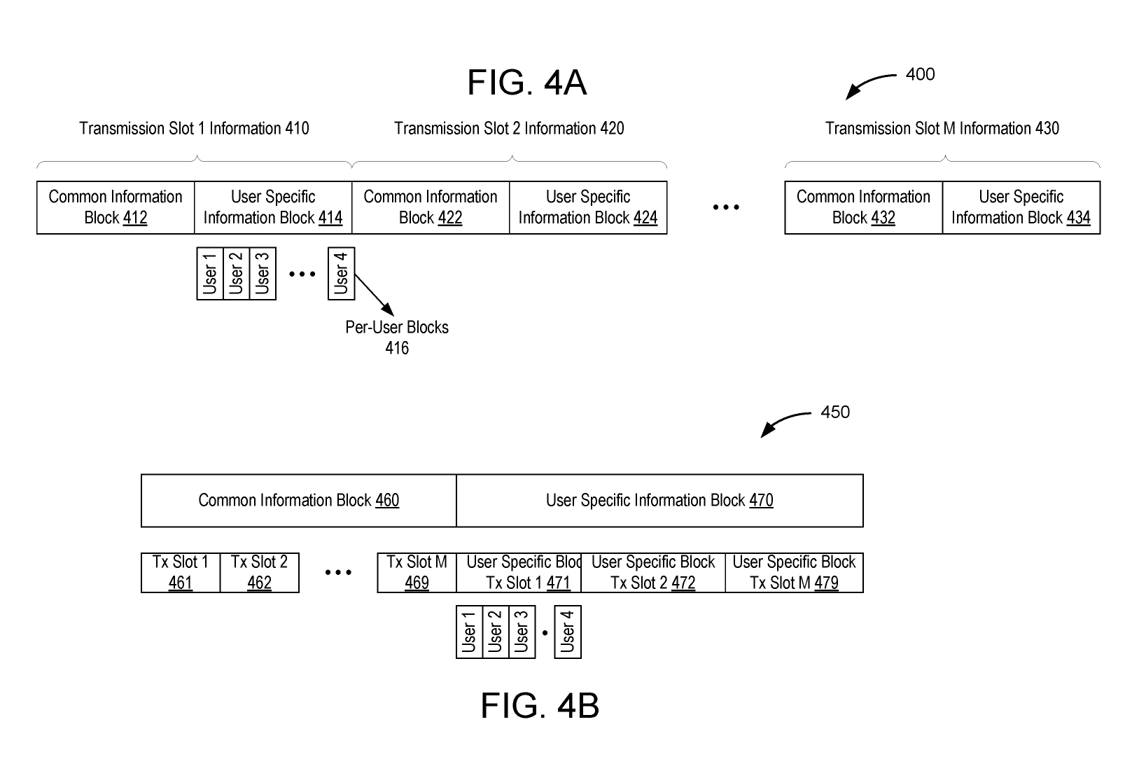

FIG. 4A illustrates an example overview of a payload arrangement 400 in an example excitation frame in accordance with some aspects.

In the payload arrangement 400, the common information and user specific information are sent separately for each transmission slot. For example, the common information block and the user specific information for transmission slot 1 is sent first followed by the common information block and the user specific information for transmission slot 2, and son on until the common information block and the user specific information for the last transmission slot are sent.

In an aspect, for example, the payload 400 (same as or similar to payload 320 of FIG. 3) may include transmission slot configuration for the various transmission slots configured by the excitation frame 212. For instance, the payload 400 may include transmission slot 1 information 410, transmission slot 2 information 420, and/or transmission slot M information 430. The transmission slot 1 information 410 may further include a common information block 412 and a user specific information block 414, the transmission slot 2 information 420 may further include a common information block 422 and a user specific information block 424, and/or the transmission slot M information 430 may further include a common information block 432 and a user specific information block 434. In an aspect, the common information block may include information that applies to all the users (e.g., STAs) scheduled for UL response frames in the respective transmission slot and the user specific information block include information that is specific to each STA scheduled for UL response frames in the respective slot. In an additional aspect, the user specific information block may include per-user blocks 416 which may contain information specific to a user. For example, user specific information block 416 may include per-user blocks, for example, for Users/STAs 1, 2, 3, and 4 which are scheduled for UL response frames in transmission slot 1 as defined by transmission slot configuration 220 of FIGS. 2A and 2B

FIG. 4B illustrates another example overview of a payload arrangement 450 in an example excitation frame in accordance with some aspects.

In the payload arrangement 450, the common information for all transmissions is combined and transmitted first followed by the combined user specific information for all transmissions slot.

In an aspect, for example, the payload 450 (same as or similar to payload 320 of FIG. 3) may include a common information block 460 and a user specific information block 470. The common information block 460 contains information common to all users/STAs scheduled for UL response frames in all the transmission slots configured by the excitation frame 212. That is, the common information block 460 includes information similar to the information contained in all common information blocks of FIG. 4A, but together in one common information block 460. Additionally, user specific information block 470 contains information specific for each user in each transmission slot for all the transmission slots configured by the excitation frame 212. That is, user specific information block 470 includes information similar to the information contained in user specific information blocks of FIG. 4A, but together in one user specific information block 470. In other words, the common information blocks for the all the transmission slots are combined and transmitted as one common information block 460. Similarly, user specific information blocks described in FIG. 4A are combined together and transmitted as one user specific information block 470.

The common information block 460 may further include information specific to each of the transmission slots, e.g., Tx Slot 1 461, Tx Slot 2 462, and/or Tx Slot M 469 and/or user specific information block 470 may include user specific blocks for each transmission slot, e.g., user specific block Tx Slot 1 471, user specific block Tx Slot 2 472, and/or user specific block Tx Slot M 479. This is another way of transmitting the excitation frame 212 to the users/STAs. The payload structure defined in FIG. 4B simply provides a different structure than the payload structure defined in FIG. 4A and there may be situations in which it may not be necessary to transmit all the common information blocks and user specific information blocks for all the slots at one instance in time.

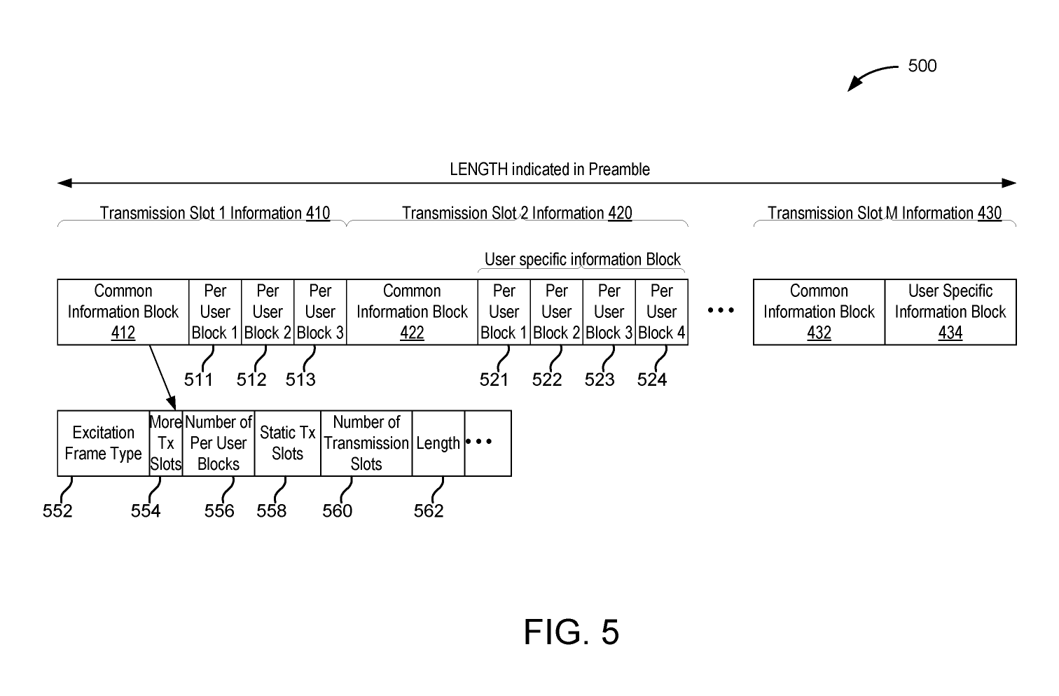

FIG. 5 illustrates an example overview of fields 500 of a common information block and/or a user specific information block in accordance with some aspects.

In an aspect, for example, the payload 500 (same or similar to the payloads 400 of FIG. 4A, 450 of FIG. 4B, and 320 of FIG. 3) may include transmission slot configuration for the various transmission slots configured by the excitation frame 212. Additionally, FIG. 5 illustrates various fields that may be added to the common information blocks, e.g., 412, 422, 432, etc. to support back-to-back UL response frames from the users/STAs. For instance, the common information block 412 may be configured to include fields such as Excitation Frame Type 552, More Tx Slots 554, Number of Per User Blocks 556, Static Tx Slots 558, Number of Transmission Slots 560, and/or Length 562, etc.

For example, in an aspect, the Excitation Frame Type 552 field may provide for defining variations of excitation frame type, the More Tx Slots 554 field may indicate whether the associated transmission slot is the last transmission slot or not (e.g., may be 1 bit), the Number of Per User Blocks 556 field may indicate total number of per user blocks after the common information block for the associated transmission slot which may be used by the receiver to determine the location of the next common information block. Additionally, the Number of Per User Blocks 556 field is configured to have enough bit width to enable signaling multiple per-user blocks to the STAs, for example, 10-bit wide to support signaling to 1024 users (e.g., STAs).

The Static Tx Slots 558 field indicates that the common information blocks and the user information blocks of all the transmission slots are identical (which may be indicated using 1 bit, for example). In such an example configuration, there may not be a need to carry multiple identical common information blocks or identical user specific information blocks. Instead, AP 150 may configure only one common information block and one user specific information block to be transmitted to the users/STAs in the excitation frame 212. The Static Tx Slots 558 field, in an aspect, when set to a value of “1,” may indicate that only one common information block and user specific information block are present and that these two blocks apply to all the transmission slots.

Further, the Number of Per User Blocks 556 field may be redundant. As described above in reference to FIG. 3, the LENGTH field in the preamble of an excitation frame indicates the length (e.g., in octets) of the payload of the excitation frame. An excited STA (e.g., a STA receiving the excitation frame), upon checking the Static Tx Slots field interprets that a single common information block (e.g., 412) applies to a multiple Number of Transmission Slots 560. The size (in octets) of the common information block (e.g., 412) and per-user-block may be already known as they may be defined in the WLAN Specifications. In an example aspect, the size of the common information block (e.g., 412) may be defined as 8 bytes and the size of the per-user block may be defined as 5 bytes. An excited STA may compute the number of per user blocks, e.g., (LENGTH−8)/5. As the Number of Per User Blocks 556 field is redundant when the Static Tx Slots 558 field is set, the Number of Per User Blocks 556 field may be used (e.g., re-purposed) to indicate the Number of transmission slots 560 to the users. The length 562 field indicates the length of the packet to be transmitted in a transmission slot and a receiver of the excitation frame copies the value in this field into the preamble LENGTH field (e.g., preamble 310 of FIG. 3). All transmissions in a transmission slot have to be of the same duration. For this purpose, the AP 150 provides the length value in the Excitation frame for each transmission slot. The STAs copy it to avoid mismatch between the values of the LENGTH field in the preambles of the back-to-back UL response frames transmitted from the different STAs. On the other hand, identical preamble of the plurality of simultaneous UL transmissions eases the receive processing at the AP.

FIG. 6 illustrates example overviews of uplink response frame structures 600 and 650 in accordance with some aspects.

In an aspect, for example, one or more STAs (e.g., STAs 1-7) may transmit UL response frames to the AP 150 based at least on the transmission slot configuration received in the excitation frame 212. For instance, STA 1 may transmit UL response frame 600 in the first transmission slot and UL response frame 650 in any other transmission slot after the first transmission slot, e.g., transmission slot 3, etc.

The uplink response frame 600 transmitted in the first transmission slot 1 221 may include legacy fields 602 which are present for interoperability with existing (e.g., current, legacy, etc.) 802.11ax networks. For example, legacy signal (L-SIG) field (not shown in FIG. 6) may indicate LENGTH of the UL response frame copied from the Length field in the common information block. Additional fields such as a short training field, e.g., a short training field (X-STF) 604, a long training field (X-LTF) 606, and other fields in the UL response frame assist the AP 150 in automatic gain control (AGC) calibration, multiple input multiple output (MIMO) channel estimation, and other uses, respectively.

A third party STA may only defer its own transmissions until the end of the LENGTH and may try to access the channel access at the end of the LENGTH. However, the third party STA may find the channel busy due to ongoing transmissions in the next transmission slot, e.g., transmission slot 2 222.

In an additional aspect, the length field in a common information block 412 corresponding to the first transmission slot 221 indicates cumulative length of all the transmission slots. The length in the common information block corresponding to the 2nd to Mth transmission slot indicates the length of each of the transmission slots. Thus the excited STA may compute the length for the 1st transmission slot, e.g., cumulative length—length of slot 1—length of slot 2, and so on). The cumulative length may be indicated in the common information block corresponding to the 1st transmission slot, and may be copied into the LENGTH field of the preamble of back-to-back UP response frames in the 1st transmission slot. However, legacy/third party STAs after reading the LENGTH field in preamble may defer until the end of all the transmission slots.

In one implementation, to improve network performance, the UL response frame preamble 601 may be appended to the payload 610 (same as or similar to payload 320 of FIG. 3) for all transmissions in the first transmission slot. The UL response frame mid-amble 651 is appended to the payload 660 for all transmissions after the first transmission slot until the last transmission slot, i.e., from the second transmission slot to the last transmission slot. When the mid-amble 651 is transmitted, the X-STF 652 and L-STF 654 fields are used by the AP 150 for channel estimation/calibration mid-way between back-to-back UL response frames.

Additionally, the preamble and/or mid-amble of all UL response frames in a transmission slot are required to be identical to enable packet processing less challenging at the AP. Other fields that may be included in the preamble of the UL response frame are bandwidth, number of long training fields (LTFs), guard interval (GI) and LTF type, low-density parity-check (LDPC), etc.

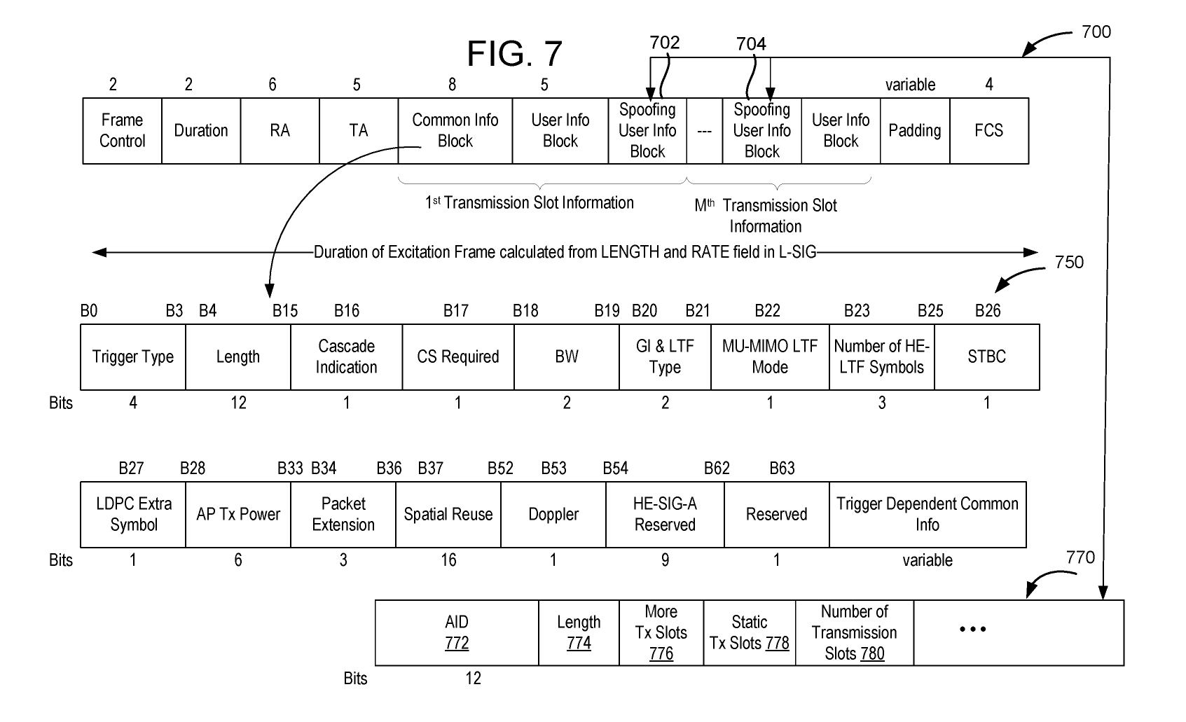

FIG. 7 illustrates an example aspect of an excitation frame 700 including a common information block 750, and/or a spoofing user info block 770 transmitted to a plurality of STAs in accordance with some aspects.

In an aspect, for example, the common information block in the second and later transmission slots, e.g., common information blocks, e.g., 422 and 432 of FIG. 4, transmitted in the excitation frame 212 may be configured as spoofing user info blocks, e.g., 702, 704, etc., and may include information such that the legacy 802.11ax STAs interpret the spoofing user info blocks as additional per-user blocks even though they are common information blocks. That is, the legacy 802.11ax STAs interpret the spoofing user info blocks as per-user blocks and the STAs of next version of 802.11ax standard or any future version of WLAN/Wi-Fi standards interpret them as additional common information blocks.

A high efficiency (HE) trigger based physical layer convergence procedure (PLCP) protocol data unit (PPDU), i.e., the PPDU, sent after the first transmission slot and until the last transmission slot may not include the HE preamble and instead may include a mid-amble that includes at least HE-STF and HE-LTF fields. Further, the common information block for the second transmission slot and beyond may be made lighter, for example, by removing HE-SIG-A field, defining the common information block of second transmission slot and beyond as spoofing user info blocks. For instance, the size of the spoofing user info blocks (e.g., 702, 704) may be configured to 5 bytes (similar to the size of a user info block), and a “User ID” (e.g., Association ID) field may be configured as the first field in this block, and special User ID value may be used to indicate that the spoofing user info block is actually a common information block for another transmission slot. Furthermore, legacy 802.11ax devices may be scheduled in the first transmission slot as the legacy 802.11ax devices may not understand the mid-amble and are generally not used to delaying the UL response frames after the end of the excitation (trigger) frame, specifically when sending the UL response frames in the first transmission slot. Thereby, false detections of the per-user field by legacy 802.11ax devices may be ameliorated by using a unique User ID in the spoofing user info block.

In one implementation, an example spoofing user info block 770, similar to spoofing user info blocks 702 and 704, which is 8 bytes (40 bits) in length is illustrated. The example spoofing user info block 770 may include an Association ID (AID) which may be 12 bits in length and may indicate a special spoof value. The spoofing user info block 770 may include additional fields such as length 774, More Tx Slots 776, Static Tx Slots 778, and/or Number of Transmission slots 780 (similar to the fields 562, 554, 558, 560) to support transmission of back-to-back UL response frames from the STAs. Additionally, the entire preamble 310 of the excitation frame 212 does not have to be transmitted after the first common information block because a mid-amble, which includes only some fields of the preamble, is sufficient. For example, fields (as indicated in frame structure 750 of FIG. 7) such as a trigger type, cascade indication, CS required, BW, LDPC Extra Symbol, AP Tx Power, Packet Extension, Spatial Reuse, Doppler, HE-SIG-A Reserved, Reserved does not have to be transmitted in the spoofed user info blocks 702, 704, etc. Additionally, fields such as GI LTF Type, MU-MIMO LTF Mode, and STBC need not be transmitted in the spoofed user info blocks 702, 704 which may improve network performance.

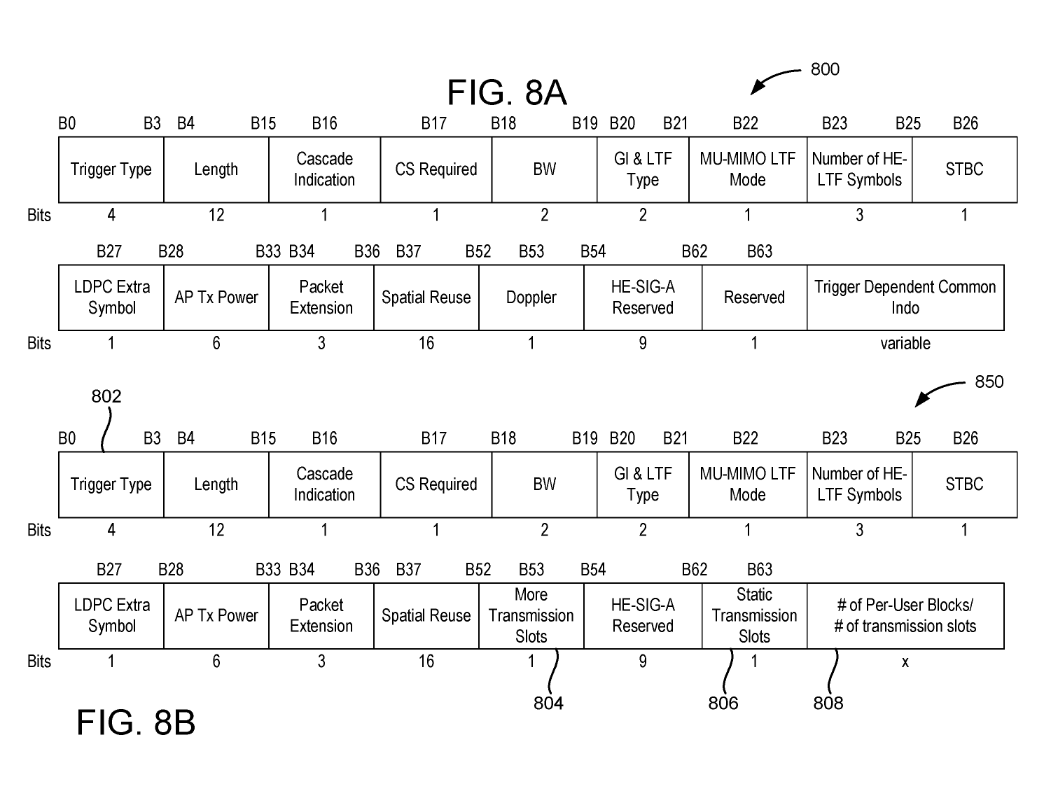

FIG. 8A illustrates a control frame, e.g., a trigger frame 800 that is defined in IEEE 802.11ax standard. FIG. 8B illustrates an example aspect of an excitation frame 850 transmitted to a plurality of STAs for transmission of back-to-back UL response frames in accordance with some aspects. The excitation frame may be an enhanced control frame of 802.11ax modified, configured, enhanced, etc. to support transmission of back-to-back UL response frames from the plurality of STAs.

In an aspect, for example, some fields in a common information block of the excitation frame 212 that support transmission of back-to-back UL response frames from the STAs are described. For instance, fields such as Trigger Type 802, More Tx Slots 804 (similar to More Tx Slots 554 of FIG. 5), Static Tx Slots 806 (similar to Static Tx Slots 558 of FIG. 5), and/or Number of per-user blocks/No. of Transmission slots (similar to Number of Per User Blocks 556/Number of Transmission Slots 560 of FIG. 5) are included either by modifying or replacing existing fields of a trigger frame in 802.11ax to support transmission of back-to-back UL response frames from the STAs. For example, a new trigger type, e.g., back-to-back UL transmissions may be defined in the Trigger type 802 field to support transmission of back-to-back UL response frames from the STAs. As the Trigger Type 802 field may support 16 values (based on an example size of 4 bits), for instance, a value of 15 may indicate back-to-back UL transmissions trigger type. The other three fields 804, 806, and/or 805 that may be configured to support back-to-back UL transmissions are described in detail in reference to FIG. 5 above.

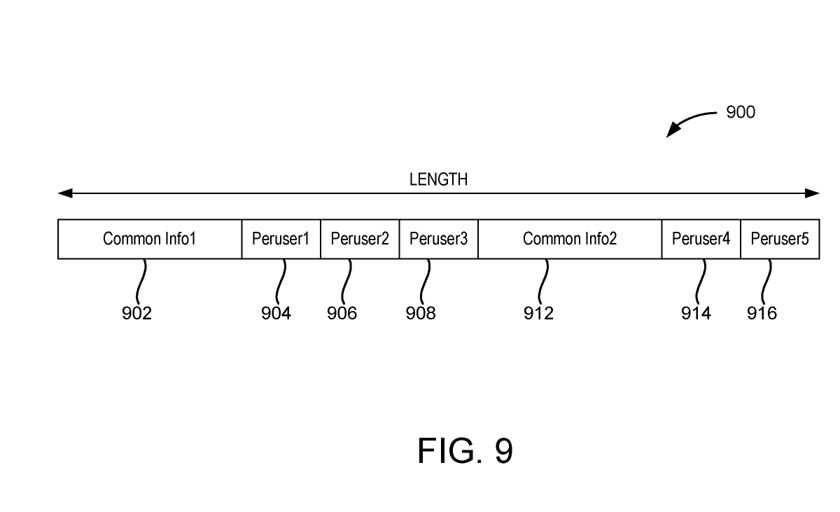

FIG. 9 illustrates an example of an excitation frame 900 transmitted to a plurality of STAs in accordance with some aspects.

In an aspect, for example, the excitation frame 900 may have similar functionality as a trigger frame in 802.11ax standard. However, 802.11ax devices may receive false detect of STA_ID and may transmit or crash. For instance, legacy 802.11ax devices may read CommonInfo1 802, Peruser1 804, Peruser2 806, and/or Peruser3 808 fields correctly. However, legacy 802.11ax devices may interpret CommonInfo2 812 field as a Peruser field and may try to parse it as a Peruser field, and may crash. Further, the first 12 bits of CommonInfo2 may correspond to an AID of a user. This could result in a false detect of per-user info and may result in unknown behavior of legacy 802.11ax devices. As a result, legacy 802.11ax devices may be scheduled only in transmission slot 1 221. Further, the probability of false detections may increase linearly with the increases in the number of STAs in the WLAN of the AP 150.

FIG. 10 illustrates an example methodology 1000 for communications between an access point (AP) and a plurality of wireless stations (STAs) in a wireless network in accordance with some aspects.

In an aspect, at block 1010, methodology 1000 may include transmitting, from the AP, a control frame to the plurality of STAs, wherein the control frame contains configuration information related to a plurality of consecutive transmission slots. For example, in an aspect, AP 150 and/or a transmitting module 170 or a transmitter 172 may include a specially programmed processor module, or a processor executing specially programmed code stored in a memory, to transmit, from AP 150, a control frame, e.g., excitation frame 212, to the plurality of STAs, e.g., STAs 1-N (1-7). The excitation frame 212 contains configuration information, e.g., transmission slot configuration 220, related to a plurality of consecutive transmission slots, e.g., slots 1-M.

In an aspect, at block 1020, methodology 1000 may include receiving, at the AP, back-to-back uplink (UL) response frames from the plurality of STAs in the plurality of consecutive transmission slots. For example, in an aspect, AP 150 and/or receiving module 180 or receiver 182 may include a specially programmed processor module, or a processor executing specially programmed code stored in a memory, to receive, at the AP 150, back-to-back uplink (UL) response frames from the plurality of STAs in the plurality of consecutive transmission slots

For instance, AP 150 may transmit, e.g., broadcast or multicast, an excitation frame 212 to the STAs. The excitation frame 212 includes transmission slot configuration 220 which identifies the transmission slots during which a STA may transmit. For example, STA 1 may receive the transmission slot configuration 220 from AP 150 and may determine that STA 1 is allowed to transmit UL response frames during transmission slots 1, 3, and M, and may transmit UL response frames accordingly. STA 1, however, waits for the duration of the inter-frame space 252 prior to the transmitting UL response frames in the transmission slot 1 221.

In another aspect, the control frame may be an excitation frame and an inter-frame space exists after end of the control frame and prior to start of a first transmission slot of the plurality of transmissions slots. In an additional aspect, AP 150 may generate the control frame to include a preamble and a payload, wherein the payload includes one or more common information blocks and one or more user specific information blocks. The payload is generated to include a first common information block and one or more second common information blocks, and wherein each of the one or more second common information blocks include an association ID (AID) field and one or more fields associated with receiving of back-to-back UL response frames in the plurality of consecutive transmission slots.

In an additional aspect, the one or more fields indicate information associated with a length, presence of additional transmission slots, presence of identical information in all transmission slots, or a number of transmission slots to the plurality of STAs. In a further additional aspect, wherein the control frame includes an indication of a trigger type configured to indicate to the plurality of STAs the use of back-to-back UL response frames.

FIG. 11 illustrates an example methodology 1100 for communications between a STA and an AP in a wireless network in accordance with some aspects.

In an aspect, at block 1110, methodology 1100 may include receiving, at the STA, a control frame from the AP, wherein the control frame contains configuration information related to a plurality of consecutive transmission slots. For example, in an aspect, STA 1 and/or receiving module 180 or receiver 182 may include a specially programmed processor module, or a processor executing specially programmed code stored in a memory, to receive, at STA 1, an excitation frame 212 from AP 150, wherein the excitation frame 212 contains configuration information related to a plurality of consecutive transmission slots, e.g., transmission slots 1-M.

In an aspect, at block 1120, methodology 1200 may include transmitting, from the STA, uplink (UL) response frames in one or more transmission slots of the plurality of consecutive transmission slots based at least on the configuration information in the control frame. For example, in an aspect, STA 1 and/or transmitting module 170 or transmitter 172 may include a specially programmed processor module, or a processor executing specially programmed code stored in a memory, to transmit from STA 1 UL response frames in one or more transmission slots of the plurality of consecutive transmission slots, e.g., transmission slots 1, 3, and M, based at least on the configuration information in the excitation frame 212.

In another aspect of methodology 1100, STA 1 may append an UL response frame preamble to a payload of a UL response frame transmitted in a first transmission slot of the plurality consecutive transmission slots; and appending an UL response frame mid-amble to a payload of each UL response frames transmitted in a second transmission slot until a last transmission slot of the plurality of consecutive transmission slots.

As such, a single excitation frame 212 may schedule back-to-back UL response frames from a plurality of STAs in multiple transmission slots. Further, the transmission of mid-ambles (instead of preambles) to perform channel estimation reduce preamble overhead. The back-to-back UL transmissions are OFDMA transmissions. The back-to-back UL response frames are useful in collecting status, e.g., buffer status and feedback, e.g., signal-to-noise ratio (SNR), channel quality indicator (CQI), etc. from a large number of STAs. Additionally, data may be transmitted from a large number of STAs to the AP.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

In the foregoing specification, aspects have been described with reference to specific examples thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

Aspects described herein may be discussed in the general context of processor-executable instructions residing on some form of processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various aspects.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, performs one or more of the methods described above. The non-transitory processor-readable data storage medium may form part of a computer program product, which may include packaging materials.

The various illustrative logical blocks, modules, circuits and instructions described in connection with the aspects disclosed herein may be executed by one or more processors, such as one or more digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structure or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other suitable configuration.

What is claimed is:

1. A method of communications between an access point (AP) and a plurality of wireless stations (STAs) in a wireless local area network (WLAN), comprising:
transmitting, from the AP, a control frame to the plurality of STAs, wherein the control frame contains configuration information related to a plurality of consecutive transmission slots; and
receiving, at the AP, back-to-back uplink (UL) response frames from the plurality of STAs in the plurality of consecutive transmission slots.

2. The method of claim 1, wherein an inter-frame space exists after end of the control frame and prior to start of a first transmission slot of the plurality of transmissions slots.

3. The method of claim 1, wherein the control frame is an excitation frame, the excitation frame including scheduling information related to the plurality of consecutive transmission slots for each of the plurality of STAs.

4. The method of claim 3, wherein the scheduling information configures the plurality of STAs to transmit the back-to-back UL response frames as orthogonal frequency-division multiple access (OFDMA) transmissions.

5. The method of claim 1, further comprising:
generating the control frame to include a preamble and a payload, wherein the payload includes one or more common information blocks and one or more user specific information blocks.

6. The method of claim 5, further comprising:
generating the payload to include a first common information block and one or more second common information blocks, and wherein each of the one or more second common information blocks include an association ID (AID) field and one or more fields associated with receiving of back-to-back UL response frames in the plurality of consecutive transmission slots.

7. The method of claim 5, wherein the one or more fields indicate information associated with a length, presence of additional transmission slots, presence of identical information in all transmission slots, or a number of transmission slots to the plurality of STAs.

8. The method of claim 1, wherein the back-to-back UL response frames correspond to a plurality of UL response frames configured without inter-frame spaces between each of the plurality of UL response frames.

9. The method of claim 1, wherein the control frame includes an indication of a trigger type configured to indicate to the plurality of STAs the use of back-to-back UL response frames.

10. A method of communications between a wireless station (STA) and access point (AP) in a wireless local area network (WLAN), comprising:
receiving, at the STA, a control frame from the AP, wherein the control frame contains configuration information related to a plurality of consecutive transmission slots; and
transmitting, from the STA, uplink (UL) response frames in one or more transmission slots of the plurality of consecutive transmission slots based at least on the configuration information in the control frame.

11. The method of claim 10, further comprising:
appending an UL response frame preamble to a payload of a UL response frame transmitted in a first transmission slot of the plurality consecutive transmission slots; and
appending an UL response frame mid-amble to a payload of each UL response frames transmitted in a second transmission slot until a last transmission slot of the plurality of consecutive transmission slots.

12. The method of claim 11, wherein the preamble includes legacy fields for inter-operability with legacy WLANs.

13. The method of claim 10, wherein the UL response frames correspond to a plurality of back-to-back UL response frames configured without inter-frame spaces between each of the UL response frames.

14. The method of claim 10, wherein the control frame is an excitation frame, the excitation frame including scheduling information related to the plurality of consecutive transmission slots.

15. The method of claim 14, wherein the scheduling information configures the transmission of the UL response frames as orthogonal frequency-division multiple access (OFDMA) transmissions.

16. An apparatus for communications between an access point (AP) and a plurality of wireless stations (STAs) in a wireless local area network (WLAN), comprising:
a memory configured to store data; and
one or more processors communicatively coupled with the memory, wherein the one or more processors and the memory are configured to:
transmit, from the AP, a control frame to the plurality of STAs, wherein the control frame contains configuration information related to a plurality of consecutive transmission slots; and
receive, at the AP, back-to-back uplink (UL) response frames from the plurality of STAs in the plurality of consecutive transmission slots.

17. The apparatus of claim 16, wherein an inter-frame space exists after end of the control frame and prior to start of a first transmission slot of the plurality of transmissions slots.

18. The apparatus of claim 16, wherein the control frame is an excitation frame, the excitation frame including scheduling information related to the plurality of consecutive transmission slots for each of the plurality of STAs.

19. The apparatus of claim 18, wherein the scheduling information configures the plurality of STAs to transmit the back-to-back UL response frames as orthogonal frequency-division multiple access (OFDMA) transmissions.

20. The apparatus of claim 16, wherein the one or more processors and the memory are configured to:
generate the control frame to include a preamble and a payload, wherein the payload includes one or more common information blocks and one or more user specific information blocks.

21. The apparatus of claim 20, wherein the one or more processors and the memory are configured to:
generate the payload to include a first common information block and one or more second common information blocks, and wherein each of the one or more second common information blocks include an association ID (AID) field and one or more fields associated with receiving of back-to-back UL response frames in the plurality of consecutive transmission slots.

22. The apparatus of claim 20, wherein the one or more fields indicate information associated with a length, presence of additional transmission slots, presence of identical information in all transmission slots, or a number of transmission slots to the plurality of STAs.

23. The apparatus of claim 16, wherein the back-to-back UL response frames correspond to a plurality of UL response frames configured without inter-frame spaces between each of the plurality of UL response frames.

24. The apparatus of claim 16, wherein the control frame includes an indication of a trigger type configured to indicate to the plurality of STAs the use of back-to-back UL response frames.

25. An apparatus for communications between a wireless station (STA) and access point (AP) in a wireless local area network (WLAN), comprising:
a memory configured to store data; and
one or more processors communicatively coupled with the memory, wherein the one or more processors and the memory are configured to:
receive, at the STA, a control frame from the AP, wherein the control frame contains configuration information related to a plurality of consecutive transmission slots; and
transmit, from the STA, uplink (UL) response frames in one or more transmission slots of the plurality of consecutive transmission slots based at least on the configuration information in the control frame.

26. The apparatus of claim 25, wherein the one or more processors and the memory are configured to:
append an UL response frame preamble to a payload of a UL response frame transmitted in a first transmission slot of the plurality consecutive transmission slots; and
append an UL response frame mid-amble to a payload of each UL response frames transmitted in a second transmission slot until a last transmission slot of the plurality of consecutive transmission slots.

27. The apparatus of claim 26, wherein the preamble includes legacy fields for inter-operability with legacy WLANs.

28. The apparatus of claim 25, wherein the UL response frames correspond to a plurality of back-to-back UL response frames configured without inter-frame spaces between each of the UL response frames.

29. The apparatus of claim 25, wherein the control frame is an excitation frame, the excitation frame including scheduling information related to the plurality of consecutive transmission slots.

30. The apparatus of claim 29, wherein the scheduling information configures the transmission of the UL response frames as orthogonal frequency-division multiple access (OFDMA) transmissions.
